(19) United States
(12) Patent Application Publication
(10) Pub. No.: US 2010/0259496 A1
(43) Pub. Date: Oct. 14, 2010

(54) ORDER RECEIVING APPARATUS AND ORDER RECEIVING METHOD

(75) Inventors: Kenji Shimizu, Shizuoka (JP); Masanori Sambe, Shizuoka (JP); Takashi Makiyama, Tokyo (JP); Yumiko Okuma, Tokyo (JP); Hisashi Sato, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/755,715

(22) Filed: Apr. 7, 2010

(30) Foreign Application Priority Data
Apr. 8, 2009 (JP) 2009-094198

(51) Int. Cl. G06F 3/048; G06F 3/041

(52) U.S. Cl. 345/173; 715/810

(57) ABSTRACT

An order receiving apparatus includes: a display control unit configured to display an order input screen on which a menu area and a details area are arranged, the menu area being an area in which operation images for receiving orders for menu items are displayed for each section of menu items and the details area being an area in which details of the menu item for which an order is received are displayed; a receiving unit configured to receive selection of a detail out of the details displayed in the details area; and a switching unit configured to switch the operation images displayed in the menu area to the operation images for receiving menu items of the section related to the menu item, whose selection of the detail is received.

### CROSS-REFERENCE TO RELATED APPLICATION

This application claims the benefit of priority from Japanese Patent Application No. 2009-094198 filed on Apr. 8, 2009, the entire content of which is incorporated herein by reference.

### TECHNICAL FIELD

The present invention relates to an order receiving apparatus set in an eating house such as a restaurant and an order receiving method for inputting guidance information for customers, order information of menus, and the like to support customer service jobs.

### BACKGROUND

For example, in a large number of eating houses such as family restaurants and bars, an order management system that can centrally manage jobs from order taking of food and drink menus to checkout is installed (see JP-A-2008-299821). The system disclosed in JP-A-2008-299821 includes a checkout apparatus such as an electronic cash register or a point of sales (POS) terminal set in a checkout counter that is a checkout place for payment, a station configured to execute, for example, management of various kinds of information transmitted from the checkout apparatus, a slip issuing printer connected to the checkout apparatus and configured to print and issue an order slip, and a kitchen printer configured to print and output a cooking instruction slip. In the system disclosed in JP-A-2008-299821, the station, the slip issuing printer, the kitchen printer, and the checkout apparatus are connected to each other via a communication line such as a local area network (LAN).

In the checkout apparatus disclosed in JP-A-2008-299821, menu items displayed in a menu item space in an order input screen are displayed for each section of the menu items. Therefore, when an operator desires to additionally order an ordered menu item included in an order list displayed near the order input screen or desires to cancel an ordered menu item and order a menu item replacing the menu item, the operator has to order the desired menu item after selecting a section of menu items displayed in the menu item space. This makes operability extremely low for the operator, resulting in a burden on the operator.

### SUMMARY

According to an aspect of the present invention, there is provided an order receiving apparatus including: a display control unit configured to display an order input screen on which a menu area and a details area are arranged, the menu area being an area in which operation images for receiving orders for menu items are displayed for each section of menu items and the details area being an area in which details of the menu item for which an order is received are displayed; a receiving unit configured to receive selection of a detail out of the details displayed in the details area; and a switching unit configured to switch the operation images displayed in the menu area to the operation images for receiving menu items of a section related to the menu item, whose selection of the detail is received.

According to another aspect of the present invention, there is provided an order receiving method including: displaying an order input screen on which a menu area and a details area are arranged, the menu area being an area in which operation images for receiving orders for menu items are displayed for each section of menu items and the details area being an area in which details of the menu item for which an order is received are displayed; receiving selection of a detail out of the details displayed in the details area; and switching the operation images displayed in the menu area to the operation images for receiving menu items of a section related to the menu item, whose selection of the detail is received.

### DESCRIPTION OF THE DRAWINGS

FIG. 1 is a schematic system diagram of the entire configuration of a customer service supporting system;

FIG. 2 is a perspective view of the external form of an information terminal, which functions as a POS terminal, viewed from the front side thereof;

FIG. 3 is a perspective view of the external form of the information terminal, which functions as a POS terminal, viewed from the rear side thereof;

FIG. 4 is a block diagram of electric connection of the information terminal;

FIG. 5 is a block diagram of electric connection of a station;

FIG. 6 is a schematic diagram of the file structure of a section file accessible by the information terminal and the station;

FIG. 7 is a schematic diagram of the file structure of a PLU file accessible by the information terminal and the station;

FIG. 8 is a block diagram of the functional configuration of the information terminal;

FIG. 9 is an exemplary front view of an order input screen;

FIG. 10 is a flowchart for explaining a flow of switching processing for menu items;

FIG. 11 is an exemplary front view of the order input screen; and

FIG. 12 is an exemplary front view of the order input screen.

### DETAILED DESCRIPTION

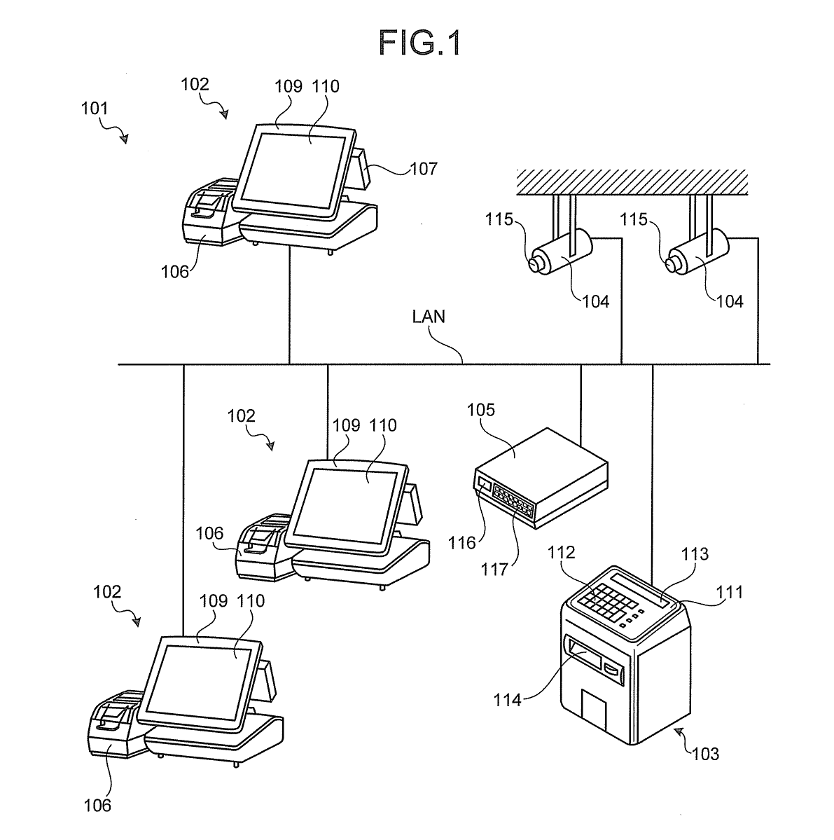

An embodiment of the present invention is explained below with reference to FIGS. 1 to 12. This embodiment is an example in which an order receiving apparatus and an order receiving method are applied to an information terminal of a customer service supporting system for supporting customer service jobs in the overall flow of customer services for guiding a customer who visits a restaurant to a table set in a customer service floor, taking an order, and serving the customer with food.

FIG. 1 is a schematic system diagram of the entire configuration of the customer service supporting system. A customer service supporting system 101 shown in FIG. 1 includes information terminals 102 set in a customer service floor and a checkout counter, a kitchen printer 103 set in a kitchen, live cameras 104 configured to pick up images of spaces above not-shown tables, and a station 105 as a server set in a backyard or the like of the restaurant and configured to control the entire customer service supporting system 101.

The information terminals 102 set in the customer service floor and the information terminal 102 set in the checkout counter have the same basic structure and basic functions. Only forms of use of the information terminals 102 are different. Specifically, the information terminals 102 set in the customer service floor support jobs such as a job for guiding customers, a job for taking orders, and a job for serving customers with food. On the other hand, the information terminal 102 set in the checkout counter supports a checkout job in addition to the job for guiding customers, the job for taking orders, and the job for serving customers with food. In other words, the information terminal 102 set in the checkout counter also functions as a so-called POS terminal. Therefore, in the customer service supporting system 101, printers 106 for issuing receipts and slips are connected to both the information terminals 102 set in the customer service floor and the information terminal 102 set in the checkout counter. On the other hand, in the customer service supporting system 101, a customer side display device 107 in addition to the printer 106 is also connected to the information terminal 102 set in the checkout counter.

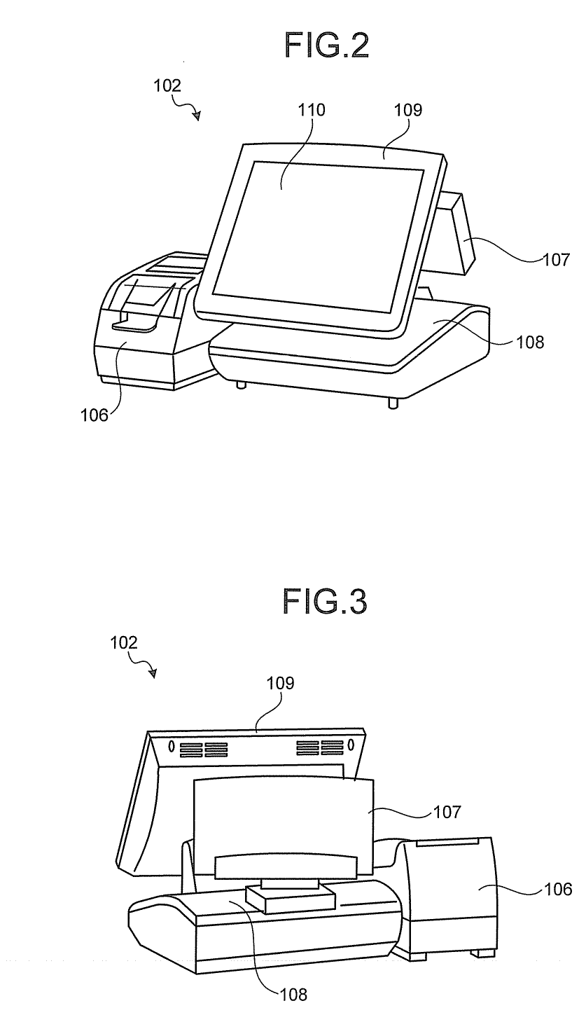

FIG. 2 is a perspective view of the external form of the information terminal 102, which functions as a POS terminal, viewed from the front side thereof. The information terminal 102 includes a main body unit 108 and a liquid crystal display 109 as a display device placed on the upper surface of the main body unit 108. In the information terminal 102, a touch panel 110 as an input device is laminated and arranged on a display surface of the liquid crystal display 109. In the customer service supporting system 101 according to this embodiment, the printer 106 is set near the information terminal 102. The printer 106 is connected to the information terminal 102 via an interface such as a USB.

FIG. 3 is a perspective view of the external form of the information terminal 102, which functions as a POS terminal, viewed from the rear side thereof. In FIG. 3, the customer side display device 107 is clearly shown. The customer side display device 107 is, as an example, an LED display device configured to display seven segments. In the information terminal 102, the customer side display device 107 is placed on the upper surface of the main body unit 108. In the customer service supporting system 101, like the printer 106, the customer side display device 107 is connected to the information terminal 102 via an interface such as a USB.

As shown in FIG. 1, the upper surface of the kitchen printer 103 is an operation display surface 111. The operation display surface 111 includes a keyboard 112 and a display 113. The kitchen printer 103 incorporates, for example, a thermal printer (not shown). The kitchen printer 103 prints and issues a cooking instruction slip (not shown) for chefs who work in the kitchen. The kitchen printer 103 issues the cooking instruction slip from a slip issue port 114 arranged in the front.

The live cameras 104 cause two-dimensional CCD arrays (not shown) to focus images captured from lenses 115. For example, the live cameras 104 amplify, A/D-convert, and filter outputs of the CCD arrays to output moving images. The live cameras 104 deliver in detail, as moving image videos, the states of spaces above plural tables (not shown) arranged in the customer service floor.

The station 105 includes, as shown in FIG. 1, a small liquid crystal display 116 and a keyboard 117. The station 105 executes, for example, management of various kinds of information transmitted from the information terminals 102.

In the customer service supporting system 101 schematically explained above, the information terminals 102, the kitchen printer 103, the live cameras 104, and the station 105 are connected to be capable of transmitting and receiving data to and from one another via the LAN. The information terminals 102 can input guide information for guiding customers to tables and order information concerning menu orders. The information terminals 102 transmit the input order information to the station 105 through the LAN. The information terminals 102 further transmit the input order information from the station 105 to the kitchen printer 103 through the LAN. The kitchen printer 103 prints and issues a slip including content corresponding to the received order information. The slip printed and issued by the kitchen printer 103 is, as explained above, the cooking instruction slip for instructing the chefs in the kitchen about the ordered menu items. The information terminal 102 functioning as the POS terminal executes checkout processing.

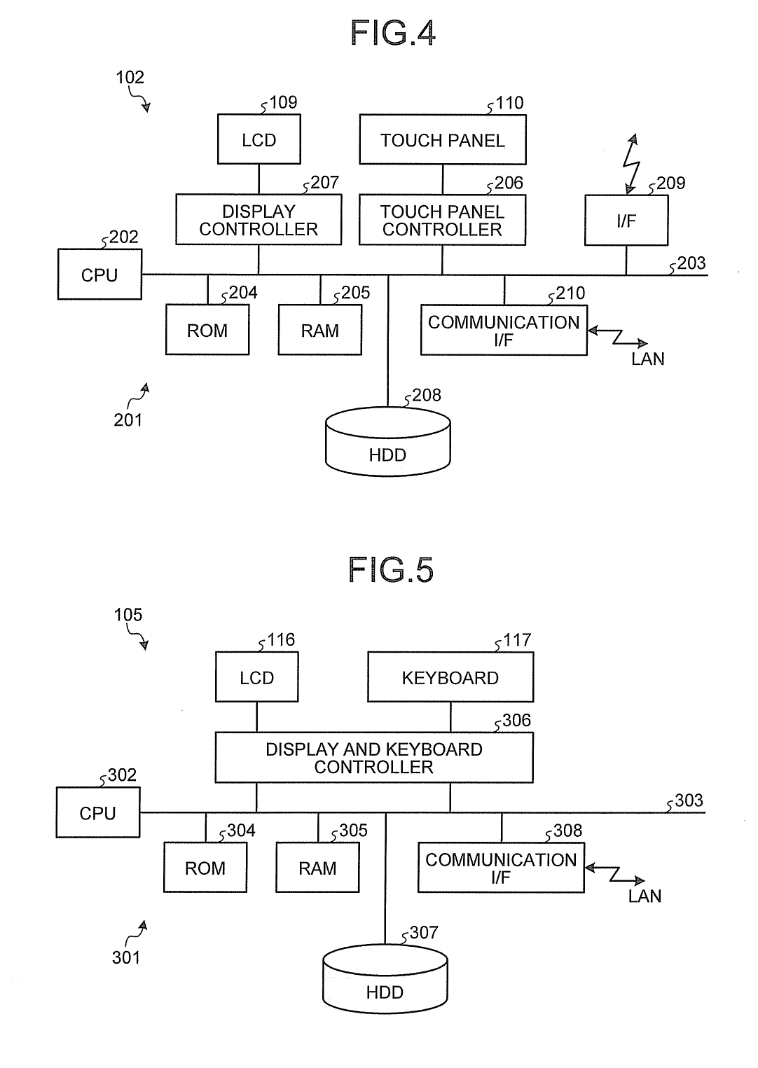

FIG. 4 is a block diagram of electric connection of the information terminal 102. As shown in FIG. 4, the information terminal 102 includes a microcomputer 201. The microcomputer 201 controls to drive the units of the information terminal 102. In the microcomputer 201, a read only memory (ROM) 204 having fixed information such as a control program stored therein in advance and a random access memory (RAM) 205 configured to rewritably store various kinds of information and function as a work area or the like are connected, via a bus line 203, to a central processing unit (CPU) 202 configured to centrally control the units. Therefore, the microcomputer 201 configures an information processing unit for executing information processing.

In the information terminal 102, a touch panel controller 206, a display controller 207, a hard disk drive (HDD) 208, an interface 209, and a communication interface 210 are connected to the microcomputer 201 via the bus line 203. The touch panel controller 206 captures an input signal from the touch panel 110 and put into the microcomputer 201. The display controller 207 displays an image corresponding to image data on the liquid crystal display 109. The interface 209 is an interface such as a USB for connecting the printer 106 and the customer side display device 107 to the microcomputer 201. The communication interface 210 is an interface for causing the microcomputer 201 to perform data communication with other apparatuses via the LAN.

In the information terminal 102, an operating system (OS), a computer program, various files, and the like are installed in the HDD 208. When the information terminal 102 is started, the microcomputer 201 copies all or a part of the OS, the computer program, the various files, and the like installed in the HDD 208 to the RM 205. The CPU 202 accesses the various files and the like copied to the RAM 205. The CPU 202 operates according to the OS and the computer program copied to the RAM 205.

FIG. 5 is a block diagram of electric connection of the station 105. As shown in FIG. 5, the station 105 includes a microcomputer 301. The microcomputer 301 controls to drive the units of the station 105. In the microcomputer 301, a ROM 304 having fixed information such as a control program stored therein in advance and a RAM 305 configured to rewritably store various kinds of information and function as a work area or the like are connected, via a bus line 303, to a CPU 302 configured to centrally control the units. Therefore, the microcomputer 301 configures an information processing unit for executing information processing.

In the station 105, a display and keyboard controller 306, an HDD 307, and a communication interface 308 are connected to the microcomputer 301 via the bus line 303. The display and keyboard controller 306 displays an image corresponding to image data on the liquid crystal display (LCD) 116. The display and keyboard controller 306 captures an input signal from the keyboard 117 and put into the microcomputer 301. The communication interface 308 is an interface for causing the microcomputer 301 to perform data communication with other apparatuses through the LAN.

In the station 105, an OS, a computer program, various files, and the like are installed in the HDD 307. The microcomputer 301 copies all or a part of the OS, the computer program, the various files, and the like installed in the HDD 307 to the RAM 305. The CPU 302 accesses the various files and the like copied to the RAM 305. The CPU 302 operates according to the OS and the computer program copied to the RAM 305.

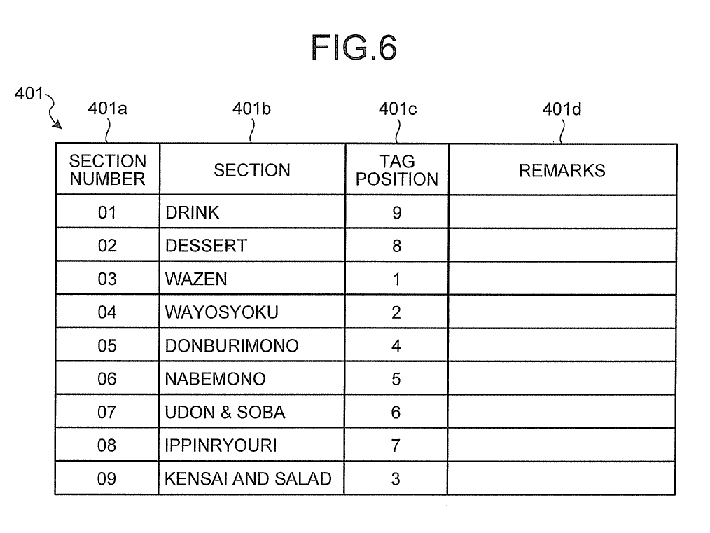

FIG. 6 is a schematic diagram of the file structure of a section file 401 accessible by the information terminals 102 and the station 105. In the information terminals 102 and the station 105, the section file 401 is installed in the HDD 208 of each of the information terminals 102 and in the HDD 307 of the station 105. The station 105 downloads the document file 401 installed in the HDD 307 of the station 105 to the HDD 208 of the information terminal 102, for example, at the update of the section file 401 or at night after the closing time such that no discrepancy occurs between the section file 401 installed in the HDD 208 and the section file 401 installed in the HDD 307.

In the section file 401, a section 401b, a tag position 401c, and remarks 401d are registered in association with a two-digit section number 401a. As an example, as the section number 401a, the following numbers are associated with sections:

01: drink

02: dessert

03: wazen

04: wayosyoku

05: donmono

06: nabemono

07: udon and soba

08: ipinryouri

09: kensai and salad

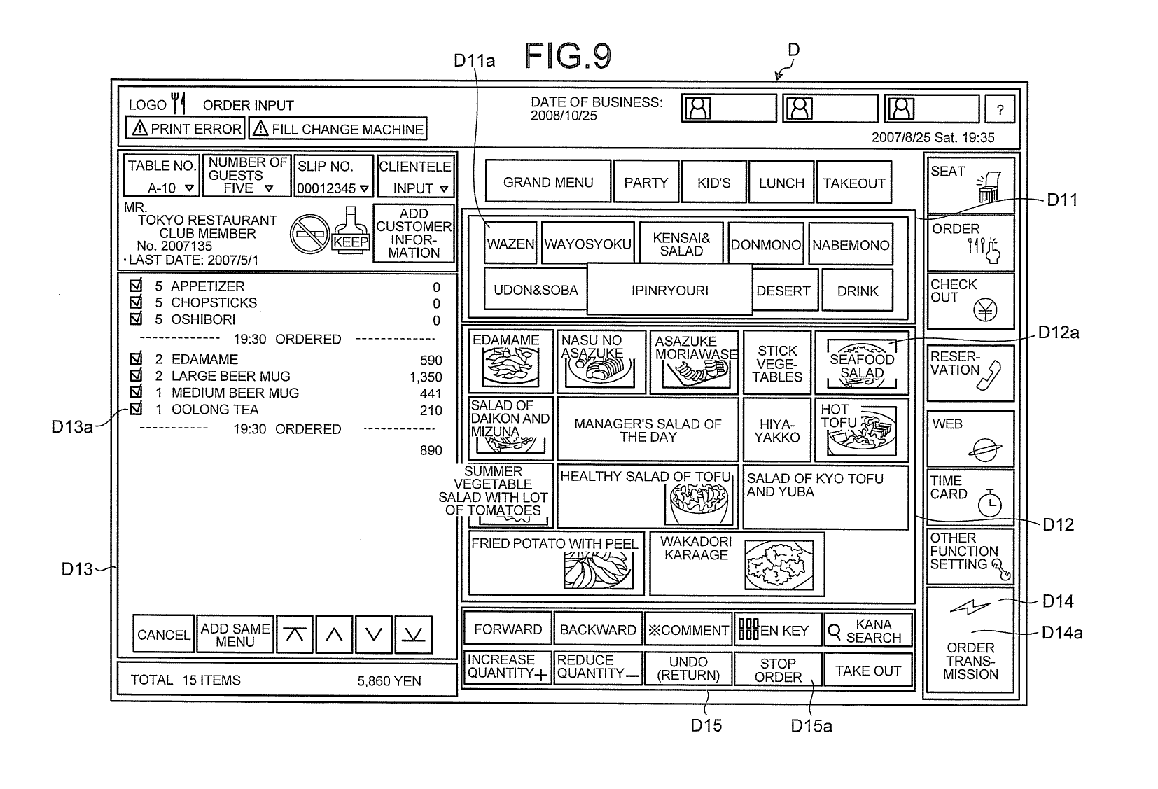

The section file 401 has names of sections registered in the section 401b. In the section file 401, the allocation of the sections 401b to a section area D11 (see FIG. 9) displayed on an order input screen D is registered in the tag position 401c. The remarks 401d is a column in which various kinds of information can be written for, for example, information management.

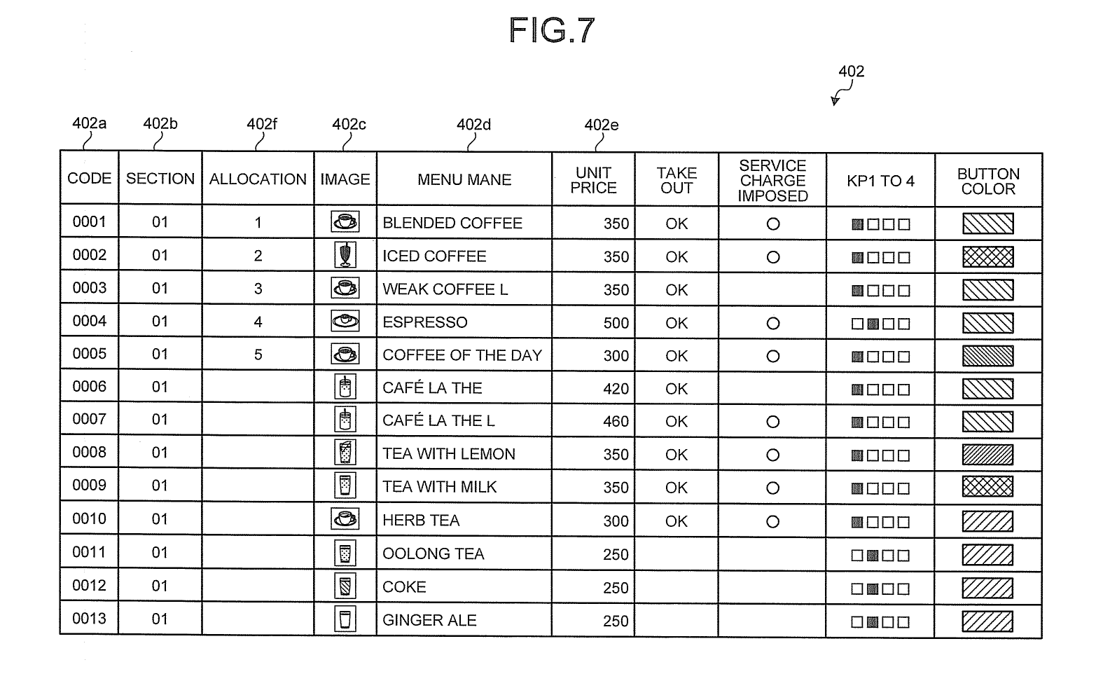

FIG. 7 is a schematic diagram of the file structure of a PLU file 402 accessible by the information terminal 102 and the station 105. In the information terminals 102 and the station 105, the PLU file 402 is installed in the HDD 208 of each of the information terminals 102 and in the HDD 307 of the station 105. The station 105 downloads the PLU file 402 installed in the HDD 307 thereof to the HDD 208 of the information terminal 102, for example, at the update of the PLU file 402 or at night after the closing time such that no discrepancy occurs between the PLU file 402 installed in the HDD 208 and the PLU file 402 installed in the HDD 307.

In the PLU file 402, a section 402b, an image link 402c, a menu name 402d, a unit price 402e, allocation 402f, and the like are registered in association with a code 402a of four digits. The section 402b represents sections registered in the section 401b in the section file 401. The image link 402c represents link to image data displayed on menu buttons D12a in a menu area D12 (see FIG. 9). In the information terminals 102 and the station 105, image data is installed in the HDD 208 of each of the information terminals 102 and in the HDD 307 of the station 105. In the PLU file 402, names of menu items are registered in the menu name 402d. In the PLU file 402, unit prices of the menu items are registered in the unit price 402e. Further, in the PLU file 402, allocation positions of the menu buttons D12a in the menu area D12 (see FIG. 9) of the menu items are registered in the allocation 402f.

For example, as it is seen from FIGS. 6 and 7, a code “0001” defines “blended coffee” of a section “drink” and sets a unit price “¥350”. A code “0002” defines “iced coffee” of the section “drink” and sets the unit price “¥350”.

Characteristic processings of the information terminal 102 according to this embodiment among processings executed by the microcomputer 201 according to the OS and the computer program installed in the HDD 208 of the information terminal 102 are explained below.

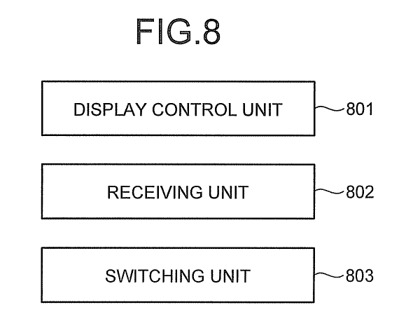

The computer program executed by the information terminal 102 according to this embodiment has a module configuration including units (a display control unit 801, a receiving unit 802, and an switching unit 803) shown in FIG. 8. As actual hardware, the CPU 202 of the microcomputer 201 reads out the computer program from the HDD 208 and executes the computer program, whereby the units are loaded onto the RAM 205 and the display control unit 801, the receiving unit 802, and the executing unit 803 are generated on the RAM 205.

The display control unit 801 displays an order input screen D shown in FIG. 9 on the liquid crystal display 109. The display control unit 801 displays the order input screen D in which the section area D11, the menu area D12, a details area D13, a job designation area D14, a function area D15, and the like are arranged.

The display control unit 801 displays, in the section area D11, section buttons D11a on which section names registered in the section 401b in association with the section number 401a of the section file 401 are displayed. The display control unit 801 displays the section buttons D11a as objects, which can be touch-designated on the touch panel 110, in the section area D11.

The display control unit 801 displays, in the menu area D12, menu buttons D12a on which image data at link destinations defined by the image link 402c in association with the code 402a of the PLU file 402 and item names registered in the menu name 402d are displayed. The menu buttons D12a are operation images for receiving orders of menu items. The display control unit 801 displays, for each of sections corresponding to the touch-designated section buttons D11a, the menu buttons D12a in the menu area D12 as objects that can be touch-designated on the touch panel 110.

The display control unit 801 arranges, in time series for respective menu items for which orders are received at the same time, details D13a including menu items that are touch-designated on the order input screen D of the touch panel 110 and for which orders are received, the numbers of orders, and amounts (unit prices×the numbers of orders) and displays the details D13a in the details area D13. The display control unit 801 displays the details D13a in the details area D13 as objects that can be touch-operated on the touch panel 110.

The display control unit 801 displays, in the job designation area D14, job designation keys D14a for designating execution of various jobs such as “checkout” related to execution of checkout processing and “order transmission” related to execution of order transmission. The display control unit 801 displays the job designation keys D14a in the job designation area D14 as objects that can be touch-designated on the touch panel 110.

The display control unit 801 displays, in the function area D14, function keys D15a for designating execution of various functions such as “increase quantity” related to execution of processing for increasing the number of orders and “reduce quantity” related to execution of processing for reducing the number of orders. The display control unit 801 displays the function keys D15a in the function area D14 as objects that can be touch-designated on the touch panel 110.

In such an order input screen D, a user can select, in inputting a menu item to be ordered, a desired section out of “drink”, “dessert”, “wazen”, “wayosyoku”, “donburimono”, “nabemono”, “udon & soba”, “ippinryouri”, and “kensai and salad” by touch-designating a desired section button D11a. For example, the display control unit 801 displays, when the user touch-designates the section button D11a of “ippinryouri” among the section buttons D11a displayed in the section area D11, the order input screen D is displayed including the menu area D12 in which the menu buttons D12a of menu items belonging to “ipinryouri” illustrated in FIG. 9 are arranged.

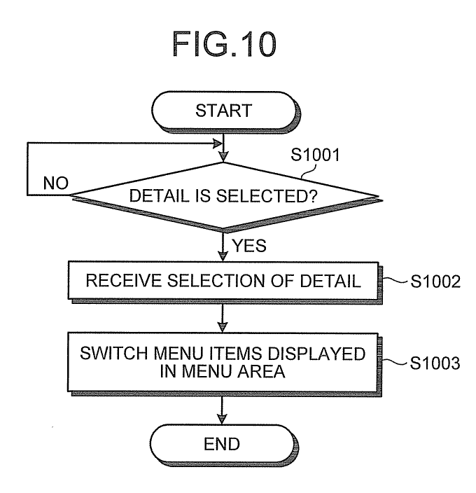

Switching processing for menu items displayed in the menu area D12 of the order input screen D explained above is explained below. FIG. 10 is a flowchart for explaining the flow of the switching processing for menu items.

If the receiving unit 802 determines that any one of the details D13a displayed in the details area D13 is touch-designated and the detail D13a is selected (Yes in Act 1001), the receiving unit 802 receives the selection of the touch-designated detail D13a (Act 1002)

In this embodiment, when the detail D13a is touch-designated, the receiving unit 802 determines that the detail D13a is selected. However, the present invention is not limited to this. For example, when the detail D13a displayed in the details area D13 is touch-designated and the function key D15a of “order stop” displayed in the function area D15 is touch-designated to correct the order for the detail D13a, the receiving unit 802 can also determine that the detail D13a is selected and receive the selection of the detail D13a, the order for which is corrected.

When the selection of the detail D13a is received by the receiving unit 802, the display control unit 801 can also display the detail D13a, the selection of which is received, as a special image, for example, by displaying the detail D13a in a color different from that of the other details D13a.

When the selection of the detail D13a is received by the receiving unit 802, the switching unit 803 switches the menu buttons D12a displayed in the menu area D12 to the menu buttons D12a of the section to which the menu item of the detail D13a, the selection of which is received, belongs (Act 1003). In this embodiment, the switching unit 803 switches the menu buttons D12a displayed in the menu area D12 to the menu buttons D12a of the section to which the menu item of the detail D13a, the selection of which is received, belongs. However, the present invention is not limited to this as long as the menu buttons D12a displayed in the menu area D12 are switched to the menu buttons D12a of the section related to the menu item of the detail D13a, the selection of which is received.

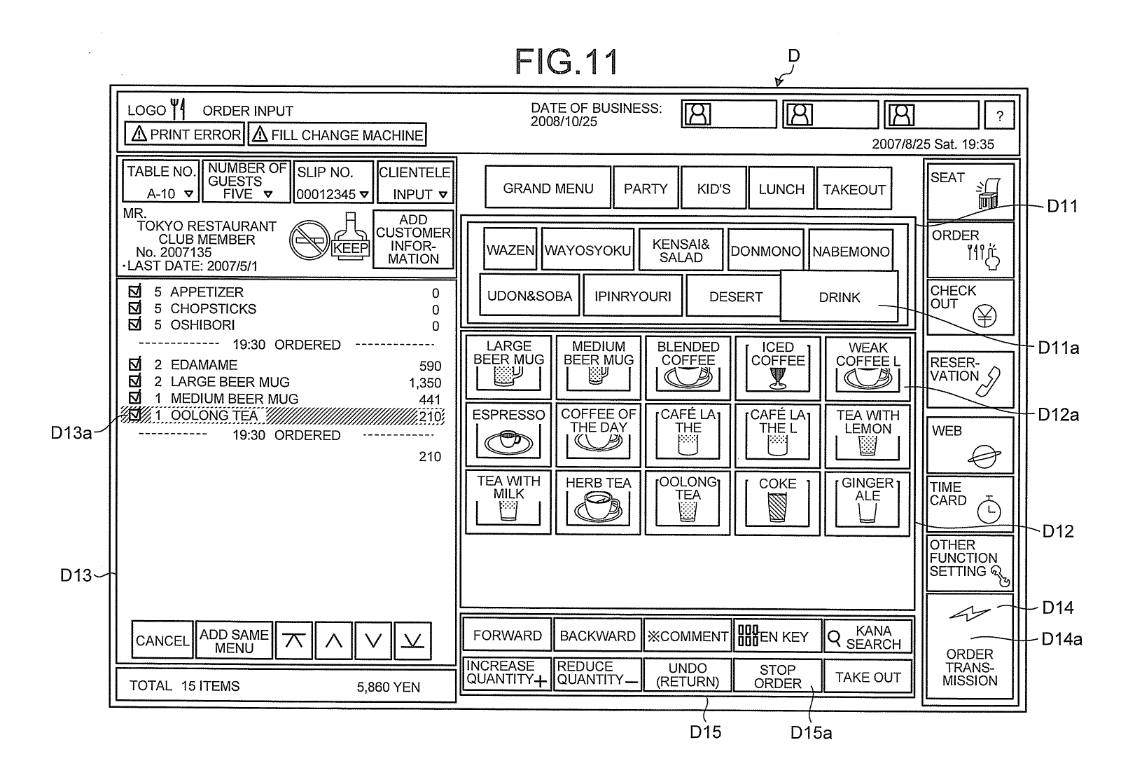

FIG. 11 is an exemplary front view of the order input screen D. In the order input screen D shown in FIG. 9, when the selection of the detail D13a of “oolong tea” displayed in the details area D13 is received, the switching unit 803 switches as shown in FIG. 11, the menu buttons D12a displayed in the menu area D12 to the menu buttons D12a of menu items belonging to the section 401b “drink” to which “oolong tea” belongs.

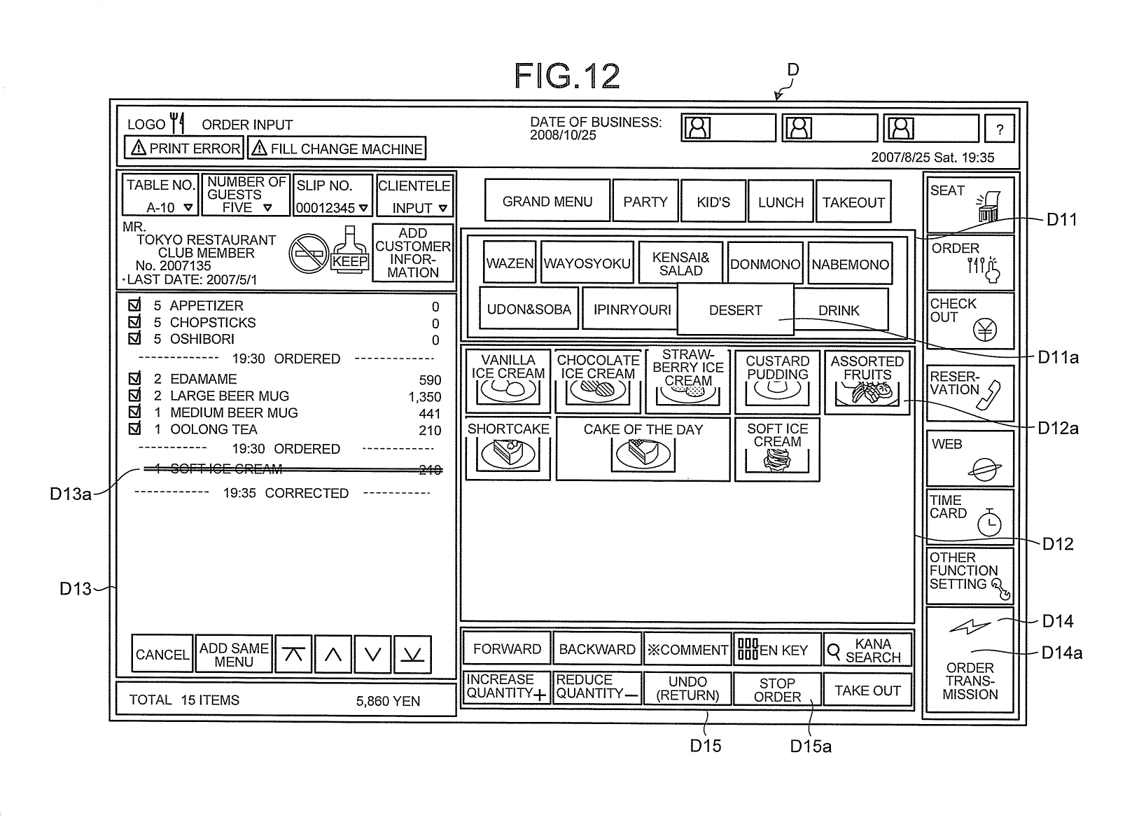

FIG. 12 is an exemplary front view of the order input screen D. As shown in FIG. 12, when an order for the detail D13a of “soft ice cream” displayed in the details area D13 is corrected, the switching unit 803 switches the menu buttons D12a displayed in the menu area D12 to the menu buttons D12a of menu items belonging to the section 401b “dessert” to which “soft ice cream” belongs.

As explained above, according to this embodiment, when the operator touch-designates the detail D13a displayed in the details area D13, the menu buttons D12a of the section to which the menu item of the touch-designated detail D13a belongs can be automatically displayed in the menu area D12. Therefore, the operator can additionally order the menu item of the detail D13a displayed in the details area D13 with ease.

According to this embodiment, the menu buttons D12a of the section to which the menu item of the detail D13a, the order for which is corrected, belongs can be automatically displayed in the menu area D12. Therefore, the operator can easily order a menu item replacing the menu item of the detail D13a, the order for which is corrected.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. An order receiving apparatus comprising:
a display control unit configured to display an order input screen on which a menu area and a details area are arranged, the menu area being an area in which operation images for receiving orders for menu items are displayed for each section of menu items and the details area being an area in which details of the menu item for which an order is received are displayed;
a receiving unit configured to receive selection of a detail out of the details displayed in the details area; and
a switching unit configured to switch the operation images displayed in the menu area to the operation images for receiving menu items of a section related to a menu item, whose selection of the detail is received.

2. The apparatus according to claim 1, wherein the display control unit displays, as a special image, the detail of the menu item, the selection of which is received, among the details displayed in the details area.

3. The apparatus according to claim 1, wherein the display control unit arranges, in time series for respective items received at same time, the details displayed in the details area and displays the details.

4. The apparatus according to claim 1, wherein the receiving unit receives selection of a detail, an order for which is corrected, out of the details displayed in the details area.

5. The apparatus according to claim 2, wherein the display control unit displays the detail of the menu item, the selection of which is received, as the special image displayed in a color different from that of the other details.

6. The apparatus according to claim 1, wherein the operation images are images in which names of menu items are displayed.

7. The apparatus according to claim 1, wherein the display control unit displays the order input screen on a liquid crystal display.

8. The apparatus according to claim 7, wherein
a touch panel is laminated and arranged on a display surface of the liquid crystal display,
the display control unit displays the operation images as objects that can be touch-designated, and
the receiving unit further receives an order of a menu item, the operation image of which is touch-designated.

9. The apparatus according to claim 8, wherein
the display control unit displays, as the objects that can be touch-designated, the details displayed in the details area, and
the receiving unit receives selection of a touch-designated detail out of the details displayed in the details area.

10. An order receiving method comprising:
displaying an order input screen on which a menu area and a details area are arranged, the menu area being an area in which operation images for receiving orders for menu items are displayed for each section of menu items and the details area being an area in which details of the menu item for which an order is received are displayed;
receiving selection of a detail out of the details displayed in the details area; and
switching the operation images displayed in the menu area to the operation images for receiving menu items of a section related to the menu item, whose selection of the detail is received.
